(19) United States
(12) Patent Application Publication
(10) Pub. No.: US 2009/0220730 A1
(43) Pub. Date: Sep. 3, 2009

(54) Material Plate

(76) Inventor: David Elwyn Price, Konigstein (DE)

Correspondence Address: GOODMAN, ALLEN & FILETTI PLLC, 4501 HIGHWOODS PARKWAY, SUITE 210, GLEN ALLEN, VA, 23060, US

(21) Appl. No.: 12/137,329

(22) Filed: Jun. 11, 2008

(30) Foreign Application Priority Data
Jun. 11, 2007 (DE) 20 2007 008 360.2

(51) Int. Cl. D06N 7/00; B32B 7/12; B32B 5/16; D06N 7/04

(52) U.S. Cl. 428/106; 428/143; 428/142; 428/110; 428/113

(57) ABSTRACT

A material plate suitable for use as a floor covering comprises a middle substrate layer having two sides and a first and second decor layer on each side of the substrate. The decor layers may be advantageously different in aesthetic appearance. A transparent overlay layer is provided over the one and preferably both decor layers. Either the decor layers or the overlay layers, or both, comprise abrasion-resistant particles to extend wear.

### RELATED APPLICATIONS

This application claims priority from and incorporates by reference, German utility model application DE 20 2007 008 360.2.

### BACKGROUND OF THE INVENTION

1. Field of the Invention

The invention relates to a material plate, in particular a material plate to be used as floor covering, comprising at least one middle substrate layer (carrier plate) and a decor layer on at least a first side of the substrate layer.

2. Introduction

The manufacture of material plates that are to be used as floor covering is accomplished by using substrates which are frequently made from a fibrous material and which are coated with a defined sequence of paper or nonwoven layers, the individual layers being impregnated with an amino resin, e.g. melamine formaldehyde resin, and cured in a press. During pressing under heat and pressure, the composition is cured to an amino resin layer and connects the individual layers with the substrate layer, so that a very stable and non-crushable surface is formed. In order to increase the abrasion resistance of the manufactured floor covering, a layer of abrasion-resistant particles may be incorporated into the uppermost layer or one of the upper layers, so that a decor layer embedded in amino resin will not be prematurely worn out. For this purpose, particles of corundum, previously cured melamine or glass are usually incorporated into the uppermost layer in order to render the layer more abrasion-resistant and more stable against wear.

The abrasion-resistant particles may, in some instances, be so hard that they also subject the press plates used for the manufacture of the material plate to high wear. Therefore, the layer with the abrasion-resistant particles may be covered with a further layer, an overlay layer, so that the abrasion resistant particles do not come into direct contact with the press plate and thus do not destroy it. This is particularly important when the work press comprises a certain pattern (press plate—structure) or has a high degree of gloss that must be maintained at constant quality during a high number of pressing operations, so that the material plates of different pressing cycles/pressing batches have the same degree of gloss and can thus be laid one next to the other as flooring without the material plates having varying degrees of gloss, a characteristic which is aesthetically unappealing and, therefore, unacceptable. During pressing and heating of the not yet cured amino resins onto the substrate layer, humidity of the not yet cured amino resin is pressed into the substrate layer, and on the side of the substrate layer facing away from the coating, the substrate is dehumidified by heat.

The intensive heat treatment can result in the material plate comprising a slight curvature after cooling and storage due to the different degree of humidity present on opposite sides of the substrate layer. Controlling the curvature of the coated substrates is an essential task of material plate production in the production process, since excessive curvature can, for instance, result in an unacceptable floor covering when the individual laminated floor covering pieces are laid.

For this reason, a counteracting paper is applied onto the side opposite the decor layer (the reverse side of the substrate panel). This counteracting paper is used to compensate and equalize the bending effects that arise on the decor side during layering. In order to save costs of manufacture, a simple recycled paper is selected as counteracting paper. The counteracting paper is also impregnated with not cured amino resin and placed and pressed in the press on the back of the material plate. However, because either side of the substrate still has different sequences of layers, curvature of the substrate layer still cannot be entirely excluded. Accordingly, a person skilled in the art is forced to determine by experimental press runs the conditions under which a material plate with an acceptable curvature is formed. In the process, it is necessary for the temperature of the press plates to be very precisely controlled on both sides of the substrate in order to manufacture a material plate comprising the desired properties. In actual operation of a manufacturing run, however, it is difficult to maintain such finely tuned conditions. Inevitably a certain percentage of faulty pressings occur resulting in material plate products with an undesired curvature or other faults, such as extreme optical damages of the decor layer or faults in the cured coating.

3. Objects of the Invention

It is therefore an object of the invention to provide a material plate, which can be manufactured with a low rate of unacceptable product. It is a further object of the invention to provide a material plate in which either side of the product may be used as the decor side at installation.

### BRIEF SUMMARY OF THE INVENTION

These objects of the invention and others are achieved by providing a decor layer on both sides of the substrate layer, wherein the decor layers can be made of a film provided with amino plastic resins, and/or of a direct decor imprint on the substrate. Further advantageous embodiments can be derived from the dependent claims.

The use of identical decor layers on both sides of the substrate advantageously allows the manufacture of floor coverings that can be laid with either one or the other side facing up in order to accommodate for possible faulty pressings. A particular piece that may not be acceptably installed in one orientation, may be acceptably installed in the reverse orientation. This added flexibility decreases the amount of unacceptable and, therefore, unusable, product

Where the material plates are manufactured with specialty designs, for example special, custom ordered (and often expensive) decor patterns and for which a low threshold of defect is acceptable, the decor pattern applied to the reverse side may be a less expensive, more readily marketable pattern, for example a light beech plank imitation, so that product which is unacceptable for the special, custom ordered application, may be acceptable for use as a mass marketed product. As a rule, the costs for a faulty pressings of specially manufactured material plates are very high, so that it is economical to provide, by way of precaution only, an alternative decor layer on the opposite side in order that, in the event that the special high-quality first decor layer is faulty, some product may still be sold in the mass market because the second lower quality side is acceptable for this purpose. Such faults can, for instance, derive from altering degrees of gloss of the press plates or altering parameters in the manufacture of the material plates. The additional cost to apply an additional decor layer is relatively low, so that even with this increased expense, the cost of faulty pressings can be mitigated. In this manner it is possible to economically and competitively manufacture individual material plates with identical or different patterns either using the first (upper) or second (lower) layer as the visible side at installation. The decor layers used may consist of a film, provided with amino plastic resins, may be a printed decor paper or may be a direct imprint on the substrate plate or any combination of these. The particular layer to be used can, of course, be selected in order for an economical production of the material plates.

In order to protect the decor layer an overlay layer covering the individual decor layer may be added on one decor layer or, preferably on both decor layer sides.

In a further embodiment of the invention, at least one, and preferably both decor layers, and one and preferably both overlay layers comprise abrasion-resistant particles. The use of abrasion-resistant particles on both sides of the substrate layer allows the use of either side of the coated plate without restrictions and provides a material plate with high abrasion resistance, irrespective of the orientation of the plate at installation. The particular advantage of this embodiment of material plates is that a particular material plate which, by its curvature or otherwise may be unacceptable because it fails to mate acceptably with adjacent material plates to create an acceptable seam, may be employed in the reverse orientation in order to create an acceptable seam with adjacent material plates. Employing this embodiment and using a popular decor, faulty pressings which would be otherwise unacceptable can be sold, particularly if the product is a mass market product.

In a further particular embodiment of the invention the decor layers or the overlay layers have abrasion-resistant particles only on the side of each layer adjacent the substrate. This measure ensures that the abrasion-resistant particles are not on the side of the layer in contact with the press plates, which can be quite sensitive to abrasion-resistant particles. Thus, the plates are protected and are usable over a substantially higher service life.

A further problem existing with some manufactured material plates is that faulty pressings may occur due to existing, unacceptable curvature of the coated panel or plate. If the material plates are to be installed in an application where adjacent material plates must join in close tolerance, for example, in some floor covering applications, the curvature must not exceed a certain tolerance. Otherwise, openings in the seams are possible, allowing possible contamination in the joint area, as well as the penetration of humidity. As a rule, manufactured material plates have an extremely slight convex curvature towards the decor layer with the curvature of the individual material plates being so insignificantly small that the material plate adopts a planar position under its own weight after it is laid as ready flooring. It is, therefore, sometimes desirable that the material plate have a slight convex curvature towards one decor side so that after laying, all adjoining floor coverings create an almost planar surface. However, obtaining this slight curvature is difficult and may be possible only by running ample test sequences using manufacturing materials having exactly the same characteristics. The manufacturer of floor covering must draw on his experience to avoid faulty pressings where the material plates have an undesired strong curvature with the concave side towards the decor layer after cooling and storage. Material plates with this characteristic are usually unsuitable, particularly for high-quality floors where seams must be created without fine cleaves at the joints. Such openings permit dirt to accumulate and allow water to soak in, thus damaging the floor covering.

For these reasons, especially for high quality flooring applications, it is essential that the curvature of a manufactured material plate be extremely small and be compensated by its own weight. A particular advantage of material plates manufactured according to the invention is, if the curvature of one side is unacceptable, the curvature for the second side may be acceptable. Alternatively, where the product is manufactured with a second decor side different from the first and which is acceptable for a lower quality flooring application, the product may be offered and used in the mass market. In either event, the number of products unacceptable for any purpose is minimized.

A further embodiment of the invention provides for a glue layer disposed between the substrate and the decor layer on at least one side. The glue layer provides additional strength to the connection between the decor layer and the substrate layer.

It must be emphasized that, in any event, the overlay layers which are used must be transparent so that the decor layers situated underneath are effective. Therefore the degree of transparency of the overlay layer used is very important. Variations in the gloss levels of the overlay layer are easily created during manufacturing. Thus, the parameters set during the press procedure are of decisive importance for the transparency of the overlay layers. The transparency can also be negatively influenced by employing too large a number of corundum particles or by the uneven distribution of particles. Finally, the quality of the color and the patterns are often determined by the transparency of the glue layer after pressing.

In order to advantageously avoid curvature of a material plate manufactured according to the invention, the sequence of layers on both sides of the substrate layers should be nearly identical, although the decor pattern on both sides of the substrate (carrier plate) may be identical or different. Preferably a standard pattern that is quite popular is chosen for the second decor, whereas the higher-value layer may have a special or rare decor pattern. Preferably the substrates layer is comprised of medium density fibreboard (MDF), high density fibreboard (HDF), particle board or oriented strand board (OSB) and is affixed to the decor layers and overlay layers after the pressing process.

It will be apparent that, in order to achieve certain qualities desired for the particular material plate to be manufactured, the nature of the layers and the sequence of the layers may be altered.

Thus, the first embodiment of the invention provides for a substrate over which a decor layer having abrasion-resistant particles is pressed to both sides. An additional embodiment of increased quality additionally comprises an overlay layer on at least one, and preferably both decor layers. The overlay layers may optionally be furnished with abrasion-resistant particles. Alternatively, for particular applications it is also possible to arrange an overlay film with or without abrasion-resistant particles, and also a decor paper with or without abrasion-resistant particles and/or an adhesive film on both sides of the substrate layer.

The invention thus provides material plates, which may be applied, for example, as a floor covering, and in which the material plates are manufactured with a nearly identical sequence of layers to both sides of the substrate layer in order that manufacturing deviations are diminished. Additionally the material plates may be installed in either orientation. Where the material plates are manufactured with two different decor layers on opposite sides, for example, one decor layer acceptable for high quality flooring and the opposite decor layer acceptable in the mass market, product which is not acceptable for the high quality flooring application may, nevertheless, be suitable for the lower quality application. In this way, the total amount of unacceptable product is diminished.

### BRIEF DESCRIPTION OF THE DRAWINGS

The invention is described with reference to the following figures, wherein

FIG. 1 shows a sequence of layers of the material plate according to the invention;

FIG. 2 shows a material plate with connection system in a cross-section; and

FIG. 3 shows a faulty pressing of a material plate according to the invention with a connection system in a cross-section.

### DETAILED DESCRIPTION OF THE INVENTION

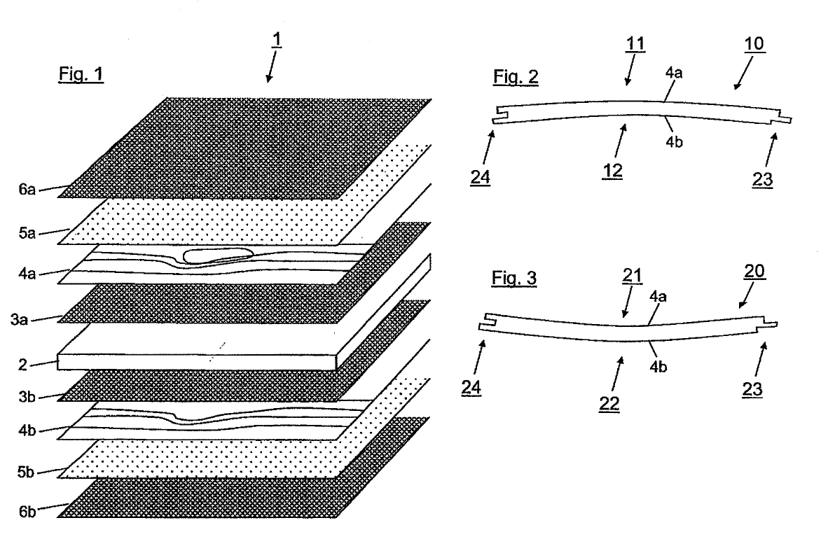

In FIG. 1 the sequence of layers of a material plate 1 according to the invention is shown. Here, a central substrate layer 2, comprised of medium density fibreboard, oriented strand board, particle board, high density fibreboard, or plywood, is covered on both sides with a glue-adhesive layer, 3a, 3b. The glue-adhesive layer may be an adhesive film. The glue-adhesive layer 3a, 3b, shown in the embodiment is not required for the invention, and is only used in particular cases during production. A sequence of layers reduced by the glue-adhesive layer 3a, 3b may also be employed. A decor layer 4a, 4b comprised of, for example, a paper of low grammage and imprinted decor is disposed over the glue-adhesive layers 3a, 3b. In prior art it is common to apply a decor layer only on one side of the substrate layer 2, and to apply a counteracting paper of non-decorative recycled paper on the back of the substrate layer. According to the invention, however, a decor layer 4a, 4b is provided on both sides, whereby both decor layers 4a, 4b may be surfaced with abrasion-resistant particles. The abrasion-resistant particles consist, for example, of corundum, fused corundum or of granular material of already cured amino resin and are located either in the decor paper 4a, 4b or in a further overlay paper 6a, 6b. For purposes of illustration, the corundum particles are shown as an intermediate layer 5a, 5b. In fact, however, the corundum particles are embedded in the overlay paper 6a, 6b or the decor paper 4a, 4b or in both papers. In order to prevent the press plates from damage when the material plate 1 is pressed, it is envisaged to place a further overlay paper 6a and 6b over the abrasion-resistant particles. The addition of a further overly paper not only does not reduce the abrasion resistance, but rather, increases it. At the same time, the press plates are protected from the harmful influences of the abrasion-resistant particles.

In FIG. 2 a material plate 10 with a desired curvature with a convex side 11 is shown in a cross-section, the convex side 11 comprising the desired decor layer 4a. In this case, the concave side 12 has another or identical decor layer 4b, which is not observable upon installation.

In FIG. 3 a material plate 20 according to the invention is shown in a cross-section, the concave and thus unusable side 21 of which comprises the desired decor 4a and the convex side of which may comprise the optional other or identical decor layer 4b. Compared to the material plate 10 in FIG. 2 the material plate 20 in FIG. 3 comprises a curvature in the opposite direction with respect to the material plate 10. The shown curvature is displayed exaggerated for better illustration, when in fact only a slight curvature may exist.

The connection element 24 can either be configured symmetric or asymmetric. FIGS. 2 and 3 show an asymmetric connection profile. The connection elements serve to create a seam between adjacent material plates laid in an application, for example, as a floor covering.

Table of reference numerals:

| Reference No. | Description |
|---|---|
| 1 | material plate |
| 2 | substrate layer |
| 3a | glue-adhesive layer |
| 3b | glue-adhesive layer |
| 4a | decor layer |
| 4b | decor layer |
| 5a | abrasion-resistant particles |
| 5b | abrasion-resistant particles |
| 6a | overlay layer |
| 6b | overlay layer |
| 10 | material plate |
| 11 | convex side |
| 12 | concave side |
| 20 | material plate |
| 21 | concave side |
| 22 | convex side |
| 23 | connection element |
| 24 | connection element |

The invention has been described in regard to its preferred embodiment. It will be apparent to those skilled in the art that the same may be varied in many ways without departing from the spirit and scope of the invention. All such modifications are intended to be included within the scope of the following claims.

I claim:

1. A material plate suitable for use as a floor covering comprising:
a central substrate layer, said central substrate layer having a first and second side;
a first decor layer disposed over said first side of said central substrate layer;
a second decor layer disposed over said second side of said central substrate layer;
wherein said first and second decor layers are impregnated with amino plastic resin and wherein at least one of said first and second decor layers comprises abrasion resistant particles.

2. A material plate according to claim 1 wherein said first and second decor layers comprise abrasion-resistant particles

3. A material plate according to claim 1 further comprising a first overlay layer disposed over said first decor layer.

4. A material plate according to claim 3 wherein said first overlay layer is transparent.

5. A material plate according to claim 3 further comprising a second overlay layer disposed over said second decor layer.

6. A material plate according to claim 4, wherein said first and second overlay layers are transparent.

7. A material plate according to claim 3 wherein at least one of said first and second overlay layers comprises abrasion resistant particles.

8. A material plate according to claim 1, further comprising a first glue-adhesive layer disposed between said central substrate layer and said first decor layer.

9. A material plate according to claim 8, further comprising a second glue-adhesive layer disposed between said central substrate layer and said second decor layer.

10. A material plate according to claim 1 wherein said first decor layer has a first decorative appearance and said second decor layer has a second decorative appearance different from said first decorative appearance.

11. A material plate according to claim 1 wherein the central substrate layer is comprised of a fibrous material selected from the group consisting of medium density fibreboard, high density fibreboard, particle board, oriented strand board and plywood.

12. A material plate according to claim 1 wherein said material plate has a slight curvature.
